(19) United States
(12) Patent Application Publication
(10) Pub. No.: US 2011/0132313 A1
(43) Pub. Date: Jun. 9, 2011

(54) INTAKE SOUND GENERATOR

(75) Inventor: Taemin Yun, Anyang-si (KR)

(73) Assignee: Hyundai Motor Company, Seoul (KR)

(21) Appl. No.: 12/873,890

(22) Filed: Sep. 1, 2010

(30) Foreign Application Priority Data
Dec. 3, 2009 (KR) 10-2009-0119120

(51) Int. Cl. F02M 35/10

(52) U.S. Cl. 123/184.57

(57) ABSTRACT

An intake sound generating apparatus may include a tuning cap having a pressing force adjusting member, an upper cap having a predetermined length and detachably coupled to the tuning cap, a lower cap disposed under the upper cap and detachably coupled to the upper cap, and a membrane that is interposed and supported between the lower cap and the upper cap and pressed by the pressing force adjusting member of the tuning cap to generate sound while being vibrated by pulse pressure of air supplied to the lower cap.

### CROSS-REFERENCE TO RELATED APPLICATIONS

The present application claims priority to Korean Patent Application Number 10-2009-0119120 filed Dec. 3, 2009, the entire contents of which application is incorporated herein for all purposes by this reference.

### BACKGROUND OF THE INVENTION

1. Field of the Invention

The present invention relates an intake sound generator, particularly an intake sound generator implementing sporty sound, using vibration of a membrane by intake pulsation in the intake port of the engine of vehicles.

2. Description of Related Art

Intake sound generators equipped in vehicles in the related art, as shown in FIG. 1, includes a tuning pipe 13 diverging from an intake channel 12 between an air cleaner 11 and the intake manifold of the engine, and a trumpet 14 disposed at the end of tuning pipe 13 to generate sound.

Trumpet 14, as shown in FIG. 2, is composed of a lower cap 14a fitted on the end of tuning pipe 13, a membrane 14b made of rubber to generating sound with vibration by pulse pressure of air, and an upper cap 14c combined with lower cap 14a to support membrane 14b therebetween.

As shown in detail through a cross section in FIG. 3, a pressing force adjusting protrusion 14ca axially protruding is formed around the inner circumference of upper cap 14c, such that it presses the edge of membrane 14b.

According to the intake sound generator having the above configuration, when air purified through air cleaner 11 flows into the engine through intake channel 12, some of the air flows to trumpet 14 through tuning pipe 13 and pulse pressure of the air generated in this process is applied to membrane 14b, such that membrane 14b vibrates and sound is generated by the vibration of membrane 14b. Accordingly, it is possible to implement sporty and strong sound and provide realistic acceleration impression for the driver.

In the intake sound generator of the related art, the length of the tuning pipe and the pressing force applied to the membrane were adjusted to produce nice sound for a driver. For this purpose, the pressing force applied to membrane 14b by pressing force adjusting protrusion 14ca was adjusted by changing the length of pressing force adjusting protrusion 14ca of upper cap 14c.

However, since it was required to change the length of the pressing force adjusting protrusion by changing a mold for the upper cap in order to change the length of pressing force adjusting protrusion 14ca, it was difficult to change the length of the pressing force adjusting protrusion. Further, it was difficult to perform tuning because there was no appropriate apparatus for attenuating the high-frequency sound of the membrane.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide an intake sound generator that can easily and conveniently adjust tone quality and tone color and implement high-quality sporty and dynamic sound by appropriately attenuating high-frequency sound generated by a membrane.

In an aspect of the present invention provides, the intake sound generating apparatus may include an upper cap, a lower cap, a membrane that is interposed and supported between the lower cap and the upper cap, and a pressing force adjusting member to press the membrane, wherein the membrane generates sound, while being vibrated by pulse pressure of air.

The intake sound generating apparatus may further include a high-frequency attenuating member that absorbs and attenuates high-frequency sound.

The intake sound generating apparatus may further include a tuning cap detachably coupled to the upper cap, wherein the tuning cap includes the pressing force adjusting member, wherein the tuning cap includes a high-frequency attenuating member that absorbs and attenuates high-frequency sound, wherein the tuning cap includes a hole and the high-frequency sound attenuating member covers the hole to absorb and attenuate high-frequency sound.

The high-frequency sound attenuating member may be a sound-absorbing foam.

The lower cap may be fitted on an end of a tuning pipe connected with an air cleaner, a first protrusion and a first groove of the upper cap is assembled with a second groove and a second protrusion of the lower cap respectively, an edge of the membrane is interposed between the first protrusion and the second groove and between the first groove and the second protrusion, and a third protrusion and a third groove of the tuning cap is assembled with a fourth groove and a fourth protrusion of the upper cap respectively.

In another exemplary embodiment of the present invention, the intake sound generating apparatus may include a tuning cap having a pressing force adjusting member, an upper cap having a predetermined length and detachably coupled to the tuning cap, a lower cap disposed under the upper cap and detachably coupled to the upper cap, and a membrane that is interposed and supported between the lower cap and the upper cap and pressed by the pressing force adjusting member of the tuning cap to generate sound while being vibrated by pulse pressure of air supplied to the lower cap, wherein the tuning cap includes a hole and a high-frequency attenuating member covers the hole to absorb and attenuate high-frequency sound.

Preferably, the tuning cap may include a pressing force adjusting protrusion having various lengths.

According to an intake sound generator according to an embodiment of the present invention, it is possible to adjust tone quality and tone cooler of the intake sound generator by manufacturing a variety of upper caps or a variety of tuning caps having various pressing force adjusting protrusions having different lengths and switching the tuning caps, such that it is possible to easily adjust the sound generated from a vehicle and improve the quality of the sound by absorbing and attenuating unpleasant sound produced by a membrane with a sound-absorbing material.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view of an intake sound generator according to the related art.

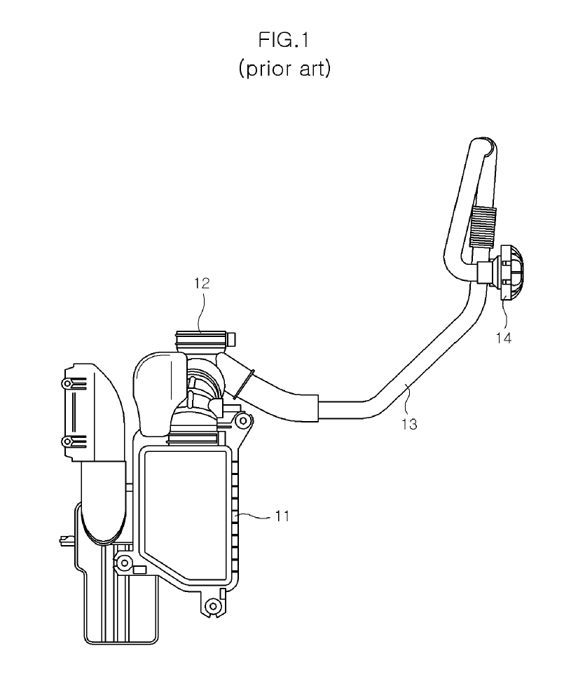

FIG. 2 is an exploded perspective view of a trumpet according to the related art.

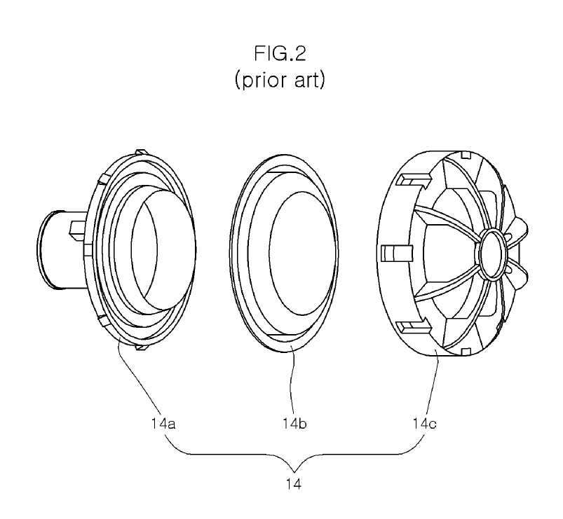

FIG. 3 is a cross-sectional view of a trumpet according to the related art.

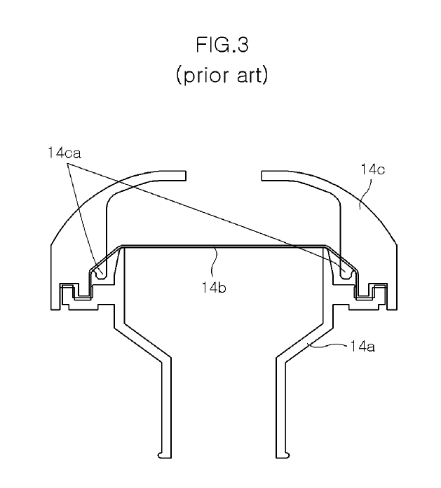

FIG. 4 is a perspective view of an exemplary intake sound generator according to the present invention.

FIG. 5 is an exploded perspective view of an exemplary trumpet according to the present invention.

FIG. 6 is a cross-sectional view of an exemplary trumpet according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, exemplary embodiments of the present invention will be described in detail with reference to the accompanying drawings.

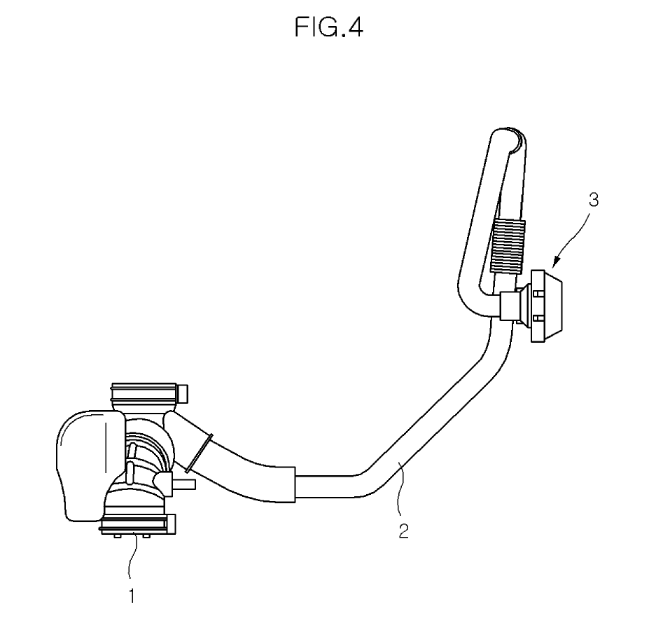

FIG. 4 is a perspective view showing the structure of an intake sound generator for a vehicle according to an exemplary embodiment of the present invention, in which one end of a tuning pipe 2 is connected to an intake channel 1 between an air cleaner that purifies and supplies external air to the engine and an intake manifold that makes the external air flow into the engine, such that some of the air purified and supplied from the air cleaner to the intake manifold flows through the tuning pipe 2.

Tuning pipe 2 is a hollow pipe having predetermined length and diameter to allow air to flow therethrough, and a trumpet 3 that produces sporty and dynamic sound while making vibration by pulse pressure of the air flowing inside through tuning pipe 2 is connected to the other end of tuning pipe 2.

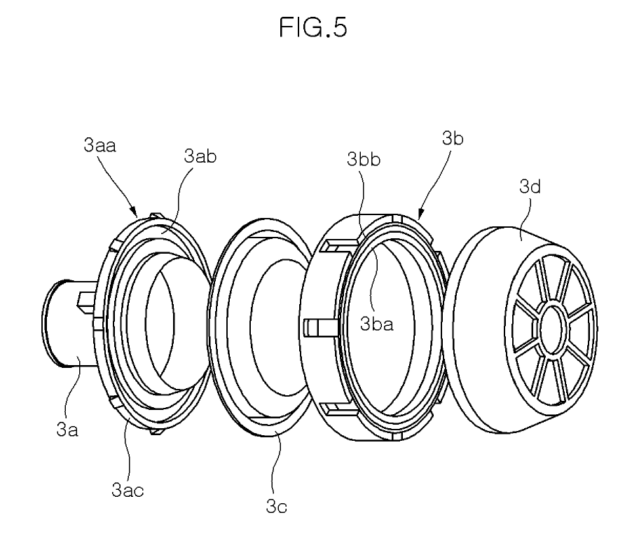

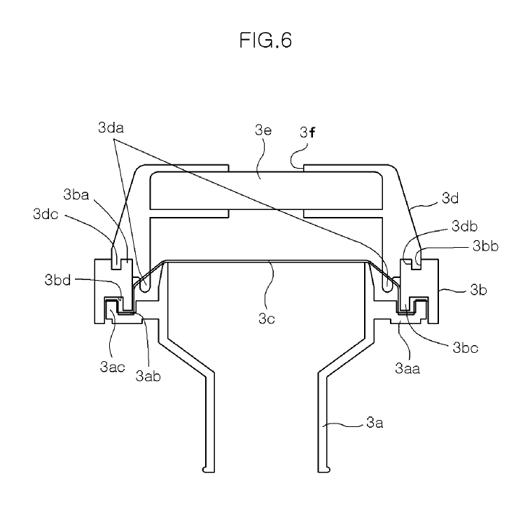

Trumpet 3, as shown in the exploded perspective view and cross-sectional view of FIGS. 5 and 6, respectively, has a lower cap 3a fitted on the other end of tuning pipe 2.

Lower cap 3a has an integral flange 3aa radially protruding and flange 3aa has a groove 3ab axially depressed and a protrusion 3ac axially protruding around the outside of the groove.

An upper cap 3b that is combined with lower cap 3a has a protrusion 3bc that has a substantially ring shape and is fitted in groove 3ab of the lower cap and a groove 3bd where protrusion 3ac of lower cap 3a is fitted, on the bottom.

Further, upper cap 3b has protrusion 3ba and groove 3bb on the upper surface, which may correspond to the protrusion and the groove on the bottom.

Lower cap 3a and upper cap 3b are combined by the protrusion 3ac and the groove 3bd and the protrusion 3bc and the groove 3ab with a membrane 3c therebetween, which is made of rubber. The outer edge of membrane 3c is interposed and fixed between the protrusion 3ac and the groove 3bd of the lower cap and the upper cap and the protrusion 3bc and the groove 3ab of the upper cap and the lower cap.

A tuning cap 3d is assembled with upper cap 3b by a protrusion 3dc and a groove 3db of tuning cap 3d which are fitted in and on the groove 3bb and a protrusion 3ba of upper cap 3b.

Tuning cap 3d has a pressing force adjusting protrusion 3da axially protruding around the inner edge, which presses membrane 3c interposed and supported between the upper cap and the lower cap.

The larger the length of pressing force adjusting protrusion 3da, the more the pressing force of the membrane increases, while the smaller the length, the more the pressing force decreases. Therefore, by manufacture tuning caps having various types of pressing force adjusting protrusions 3da having different lengths, it is possible to easily adjust the force pressing the membrane with various pressing force adjusting protrusion having different lengths, such that it is possible to conveniently and simply adjust the tone quality and tone color of the intake sound generator.

In another aspect of the present invention, by manufacture upper cap 3b having various lengths, the contact point between the pressing force adjusting protrusions 3da and the membrane 3c is changed such that it is possible to easily adjust the force pressing the membrane.

Further, a driver can easily change sound generated from a vehicle to suit his/her taste by directly adjusting the sound to be sporty, dynamic, and powerful.

Further, a sound-absorbing foam 3e is provided in the upper portion of tuning cap 3d to implement high-quality sound by absorbing and attenuating high-frequency sound.

Sound-absorbing foam 3e is fitted and supported in a hole 3f formed in tuning cap 3d.

For convenience in explanation and accurate definition in the appended claims, the terms “upper”, “lower”, “inner”, and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An intake sound generating apparatus comprising:
an upper cap;
a lower cap;
a membrane that is interposed and supported between the lower cap and the upper cap; and
a pressing force adjusting member to press the membrane,
wherein the membrane generates sound, while being vibrated by pulse pressure of air.

2. The intake sound generating apparatus as defined in claim 1, further comprising a high-frequency attenuating member that absorbs and attenuates high-frequency sound.

3. The intake sound generating apparatus as defined in claim 1, further comprising a tuning cap detachably coupled to the upper cap, wherein the tuning cap includes the pressing force adjusting member.

4. The intake sound generating apparatus as defined in claim 3, wherein the tuning cap includes a high-frequency attenuating member that absorbs and attenuates high-frequency sound.

5. The intake sound generating apparatus as defined in claim 4, wherein the tuning cap includes a hole and the high-frequency sound attenuating member covers the hole to absorb and attenuate high-frequency sound.

6. The intake sound generating apparatus as defined in claim 4, wherein the high-frequency sound attenuating member is a sound-absorbing foam.

7. The intake sound generating apparatus as defined in claim 1, wherein the lower cap is fitted on an end of a tuning pipe connected with an air cleaner, a first protrusion and a first groove of the upper cap is assembled with a second groove and a second protrusion of the lower cap respectively, an edge of the membrane is interposed between the first protrusion and the second groove and between the first groove and the second protrusion, and a third protrusion and a third groove of the tuning cap is assembled with a fourth groove and a fourth protrusion of the upper cap respectively.

8. An intake sound generating apparatus comprising:
a tuning cap having a pressing force adjusting member;
an upper cap having a predetermined length and detachably coupled to the tuning cap;
a lower cap disposed under the upper cap and detachably coupled to the upper cap; and
a membrane that is interposed and supported between the lower cap and the upper cap and pressed by the pressing force adjusting member of the tuning cap to generate sound while being vibrated by pulse pressure of air supplied to the lower cap.

9. The intake sound generating apparatus as defined in claim 8, wherein the tuning cap includes a hole and a high-frequency attenuating member covers the hole to absorb and attenuate high-frequency sound.

10. The intake sound generating apparatus as defined in claim 9, wherein the high-frequency sound attenuating member is a sound-absorbing foam.

11. The intake sound generator as defined in claim 8, wherein the lower cap is fitted on an end of a tuning pipe connected with an air cleaner, a first protrusion and a first groove of the upper cap is assembled with a second groove and a second protrusion of the lower cap respectively, an edge of the membrane is interposed between the first protrusion and the second groove and between the first groove and the second protrusion, and a third protrusion and a third groove of the tuning cap is assembled with a fourth groove and a fourth protrusion of the upper cap respectively.
